(19) United States
(12) Patent Application Publication
(10) Pub. No.: US 2025/0380195 A1
(43) Pub. Date: Dec. 11, 2025

(54) METHOD AND DEVICE FOR CONFIGURATION IN COMMUNICATION SYSTEM SUPPORTING INTEGRATED ACCESS AND BACKHAUL (IAB)

(71) Applicant: Samsung Electronics Co., Ltd., Suwon-si, Gyeonggi-do (KR)

(72) Inventors: Weiwei WANG, Beijing (CN); Hong WANG, Beijing (CN); Lixiang XU, Beijing (CN)

(21) Appl. No.: 18/876,042

(22) PCT Filed: Jun. 20, 2023
(86) PCT No.: PCT/KR2023/008552

§ 371 Date: Dec. 17, 2024

(30) Foreign Application Priority Data
Jun. 20, 2022 (CN) 202210699739.0

(51) Int. Cl. H04W 36/08; H04W 76/10; H04W 76/20; H04W 88/08; H04W 92/24

(52) U.S. Cl. CPC H04W 36/08; H04W 76/10; H04W 76/20; H04W 88/08; H04W 92/24

(57) ABSTRACT

The present disclosure provides a method and device for efficient configuration in a communication system supporting an integrated access and backhaul (IAB). A method performed by a relay node in a communication system supporting an integrated access and backhaul (IAB) is provided. The method comprises receiving configuration information from a first base station of a source cell associated with a handover of the relay node, and setting up a connection with a second base station of a target cell associated with the handover based on the first message, wherein the configuration information includes information used by the relay node for setting up the connection with the second base station.

### CROSS-REFERENCE TO RELATED APPLICATION(S)

This application is a U.S. National Stage application under 35 U.S.C. § 371 of an International application number PCT/KR2023/008552, filed on Jun. 20, 2023, which is based on and claims priority of a Chinese patent application number 202210699739.0, filed on Jun. 20, 2022, in the Chinese Intellectual Property Office, the disclosure of which is incorporated by reference herein in its entirety.

### TECHNICAL FIELD

The present disclosure generally relates to a field of communications, and more particularly to a method performed by a node, and the node.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem Solution to Problem

The present disclosure provides a method and device for efficient configuration in a communication system supporting an integrated access and backhaul (IAB).

### Technical Solution

According to an aspect of the present disclosure, there is provided a method performed by a relay node in a communication system supporting an integrated access and backhaul (IAB), the method comprises receiving configuration information from a first base station of a source cell associated with a handover of the relay node, and setting up a connection with a second base station of a target cell associated with the handover based on the first message, wherein the configuration information includes information used by the relay node for setting up the connection with the second base station.

According to an aspect of the present disclosure, there is provided a relay node in a communication system supporting an integrated access and backhaul (IAB), the relay node comprises a transceiver, and a processor configured to receive, via the transceiver, configuration information from a first base station of a source cell associated with a handover of the relay node, and set up a connection with a second base station of a target cell associated with the handover based on the first message, wherein the configuration information includes information used by the relay node for setting up the connection with the second base station.

According to an aspect of the present disclosure, there is provided a method performed by a first base station of a source cell associated with a handover of a relay node in a communication system supporting an integrated access and backhaul (IAB), the method comprises transmitting, to a second base station of a target cell associated with the handover of the relay node, a request message associated with the handover, receiving, from second base station, a response message including information on the second base station, and transmitting, to the relay node, configuration information based on the response message, wherein the configuration information includes information for setting up a connection with the second base station.

According to an aspect of the present disclosure, there is provided a first base station of a source cell associated with a handover of a relay node in a communication system supporting an integrated access and backhaul (IAB), the first base station comprises a transceiver, and a processor configured to transmit, via the transceiver to a second base station of a target cell associated with the handover of the relay node, a request message associated with the handover, receive, via the transceiver from second base station, a response message including information on the second base station, and transmit, via the transceiver to the relay node, configuration information based on the response message, wherein the configuration information includes information for setting up a connection with the second base station.

According to an aspect of the present disclosure, there is provided a method performed by a first node in a communication system. The method may include: receiving a first message from a second node; and setting up a connection with a third node according to the first message, or sending a message about configuration of a user equipment in a target cell according to the first message, wherein the first message is used by the first node for setting up the connection with the third node, or the first message is used for sending the message about the configuration of the user equipment in the target cell.

In some implementations, in the method performed by the first node, the first message may be used by the first node for setting up the connection with the third node before accessing the target cell of the third node, and the message about the configuration of the user equipment in the target cell may be a message about configuration of a target cell accessed by the user equipment after the first node accesses the target cell of the third node.

In some implementations, in the method performed by the first node, the target cell of the third node is different from the target cell accessed by the user equipment.

In some implementations, in the method performed by the first node, when the first message is used by the first node for setting up the connection with the third node, the first message may include at least one of: configuration information of a node, and first transmission configuration information.

In some implementations, in the method performed by the first node, the configuration information of the node may include at least one of: address information of the third node, and indication information of an associated cell.

In some implementations, in the method performed by the first node, the first transmission configuration information may include at least one of: Radio Resource Control (RRC) indication information, and configuration information of a backhaul link.

In some implementations, in the method performed by the first node, the configuration information of the backhaul link may include at least one of: identity information of a backhaul link channel, address information of a next hop node, the indication information of an associated cell, address information of an associated third node, identity information of an associated F1 connection, and identity information of the associated third node.

In some implementations, in the method performed by the first node, when the first message is used for sending the message about the configuration of the user equipment in the target cell, the first message may include at least one of: a fourth container, identity information of the target cell of the user equipment, identity information of an associated cell, and indication information of a conditional transmission.

In some implementations, the method performed by the first node may further include: sending a message determined according to a specific condition to the user equipment, to provide configuration information required for the user equipment to access the target cell.

According to yet another aspect of the present disclosure, there is provided a method performed by a second node in a communication system. The method may include: sending a first message to a first node, wherein the first message is used by the first node for setting up a connection with a third node, or the first message is used for sending a message about configuration of a user equipment in a target cell.

In some implementations, in the method performed by the second node, the first message may be used by the first node for setting up the connection with the third node before accessing the target cell of the third node, and the message about the configuration of the user equipment in the target cell may be a message about configuration of a target cell accessed by the user equipment after the first node accesses the target cell of the third node.

In some implementations, the method performed by the second node may further include: sending a second message to the third node; and receiving a third message from the third node, wherein when the first message is used by the first node for setting up the connection with the third node, the second message may include at least one of: first target cell information, first request indication information, and first configuration information; and wherein when the first message is used by the first node for setting up the connection with the third node, the third message may include at least one of: second target cell information, and first response indication information.

In some implementations, in the method performed by the second node, the first target cell information may include at least one of: cell identity information, and indication information of a conditional handover; in some implementations, in the method performed by the second node, the first configuration information may include at least one of: address information on a first node side, and configuration information of a data packet; in some implementations, in the method performed by the second node, the first response indication information may include at least one of: identity information of the connection, address information of the third node, and indication information of the address of the third node.

In some implementations, in the method performed by the second node, when the first message is used for transmitting the message about the configuration of the user equipment in the target cell, the second message is used for providing configuration of the user equipment at the second node, and the third message is used for providing configuration of the user equipment at the third node, and wherein the third message may include at least one of: indication information of accepted data, a third container, identity information of the target cell of the user equipment, and identity information of an associated cell.

In some implementations, in the method performed by the second node, the indication information of the accepted data may include at least one of: identity information of a Protocol Data Unit (PDU) session, resource configuration information of the PDU session, and identity information of an associated cell.

According to yet another aspect of the present disclosure, there is provided a method performed by a third node in a communication system. The method may include: receiving a second message from a second node; and sending a third message to the second node, wherein based on the third message, a first message is sent from the second node to a first node, so that the first node sets up a connection with the third node according to the first message, or sends a message about configuration of a user equipment in a target cell.

In some implementations, in the method performed by the third node, the first message may be used by the first node for setting up the connection with the third node before accessing the target cell of the third node, and the message about the configuration of the user equipment in the target cell may be a message about configuration of the target cell assessed by the user equipment after the first node accesses the target cell of the third node.

According to yet another aspect of the present disclosure, there is provided a method performed by a second node in a communication system. The method may include: receiving a fourth message from a first node, and sending a fifth message to a third node; and/or receiving a seventh message from the third node, and sending a sixth message to the first node, wherein the fourth message and the fifth message are used for transmitting an uplink data packet on an interface between the first node and the third node, and wherein the sixth message and the seventh message are used for transmitting a downlink data packet on the interface between the first node and the third node.

According to yet another aspect of the present disclosure, there is provided a method performed by a first node in a communication system. The method may include: sending a fourth message to a second node, and/or receiving a sixth message from the second node, wherein the fourth message is used for transmitting an uplink data packet on an interface between the first node and a third node, and wherein the sixth message is used for transmitting a downlink data packet on the interface between the first node and the third node.

According to yet another aspect of the present disclosure, there is provided a method performed by a third node in a communication system. The method may include: sending a seventh message to a second node, and/or receiving a fifth message from the second node, wherein the fifth message is used for transmitting an uplink data packet on an interface between a first node and the third node, and wherein the seventh message is used for transmitting a downlink data packet on the interface between the first node and the third node.

In some implementations, each of the fourth message and the fifth message may include at least one of: a first container, indication information of an associated cell, and identity information of an associated connection.

In some implementations, each of the sixth message and the seventh message may include at least one of: a second container, the indication information of the associated cell, and the identity information of the associated connection.

According to yet another aspect of the present disclosure, there is provided a method performed by a first node in a communication system. The method may include: sending an eighth message to a third node before the first node accesses a target cell of the third node; and receiving a ninth message from the third node as a response; wherein the eighth message is used for requesting to set up a connection between the first node and the third node.

According to yet another aspect of the present disclosure, there is provided a method performed by a third node in a communication system. The method may include: receiving an eighth message from a first node before the first node accesses a target cell of the third node; and sending a ninth message to the first node as a response, wherein the eighth message is used for requesting to set up a connection between the first node and the third node.

In some implementations, the eighth message may include at least one of: second configuration information, and information of an associated cell; and

In some implementations, the ninth message may include at least one of: third configuration information, and information of an associated cell.

In some implementations, the second configuration information may include at least one of: information of a served cell, cell status information, and address information.

In some implementations, the third configuration information may include at least one of: information of an activated cell, address information, and backhaul link mapping information.

According to yet another aspect of the present disclosure, there is provided a first node. The first node may include: a transceiver, configured to send and receive a signal; and a controller, coupled to the transceiver, and configured to execute a computer program to implement one of the methods performed by the first node as described above.

According to yet another aspect of the present disclosure, there is provided a second node. The second node may include: a transceiver, configured to send and receive a signal; and a controller, coupled to the transceiver, and configured to execute a computer program to implement one of the methods performed by the second node as described above.

According to yet another aspect of the present disclosure, there is provided a third node. The third node may include: a transceiver, configured to send and receive a signal; and a controller, coupled to the transceiver, and configured to execute a computer program to implement one of the methods performed by the third node as described above.

According to still another aspect of the present disclosure, there is provided a computer-readable medium, having instructions stored thereon. The instructions, when executed by a processor, cause the processor to perform the method performed by at least one of the first node to the third node as described above.

### BRIEF DESCRIPTION OF DRAWINGS

FIG. 1 illustrates an exemplary system architecture for System Architecture Evolution (SAE).

FIG. 2 illustrates an exemplary system architecture according to various embodiments of the present disclosure.

FIG. 3A, FIG. 3B and FIG. 3C illustrate exemplary block diagrams of a base station structure according to various embodiments of the present disclosure.

FIG. 4 illustrates an example of a relay network according to various embodiments of the present disclosure.

FIG. 5 illustrates a mechanism for setting up an F1 connection before a mobile terminal portion of a relay node accesses a target cell according to various embodiments of the present disclosure.

FIG. 6 illustrates an exemplary flow for setting up an F1 connection according to various embodiments of the present disclosure.

FIG. 7 illustrates an exemplary flow for performing transmission of a data packet on an F1 interface according to various embodiments of the present disclosure.

FIG. 8 illustrates an exemplary flow of a conditional setup mechanism of a connection according to various embodiments of the present disclosure.

FIG. 9 illustrates an exemplary flow of context migration of a user equipment according to various embodiments of the present disclosure.

FIG. 10 illustrates a block diagram of a node according to an example embodiment of the present disclosure.

FIG. 11 illustrates a block diagram of a user equipment according to an exemplary embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.
62As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

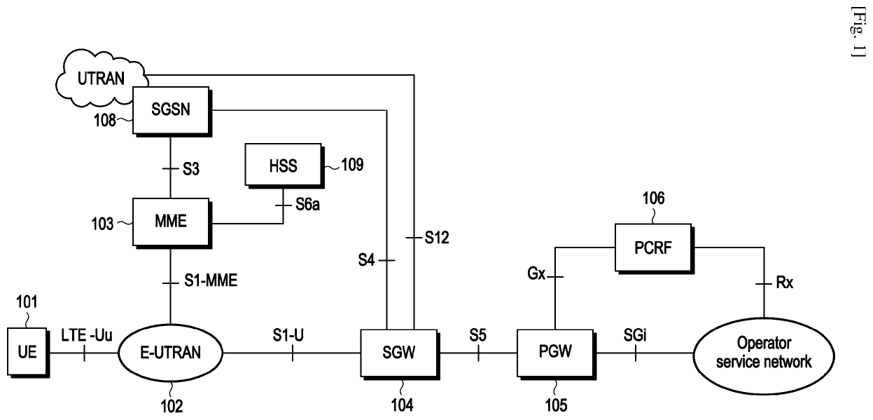

FIG. 1 to FIG. 11 discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

FIG. 1 illustrates an exemplary system architecture of System Architecture Evolution (SAE). User Equipment (UE) 101 is a terminal device for receiving data. An Evolved Universal Terrestrial Radio Access Network (E-UTRAN) 102 is a radio access network, which includes a macro base station (eNodeB/NodeB) that provides UE with interfaces to access the radio network. A Mobility Management Entity (MME) 103 is responsible for managing mobility context, session context and security information of the UE. A Serving Gateway (SGW) 104 mainly provides functions of user plane, and the MME 103 and the SGW 104 may be in the same physical entity. A packet data network gateway (PGW) 105 is responsible for functions of charging, lawful interception, interworking with external networks such as a service network, an internet, etc., and may be in the same physical entity as the SGW 104. A Policy and Charging Rules Function (PCRF) entity 106 provides quality of service (QOS) policies and charging criteria. A general packet radio service support node (SGSN) 108 is a network node device that provides routing for data transmission in a Universal Mobile Telecommunications System (UMTS). A Home Subscriber Server (HSS) 109 is a home subsystem of the UE, and is responsible for protecting user information including a current location of the user equipment, an address of a serving node, user security information, and packet data context of the user equipment, etc.

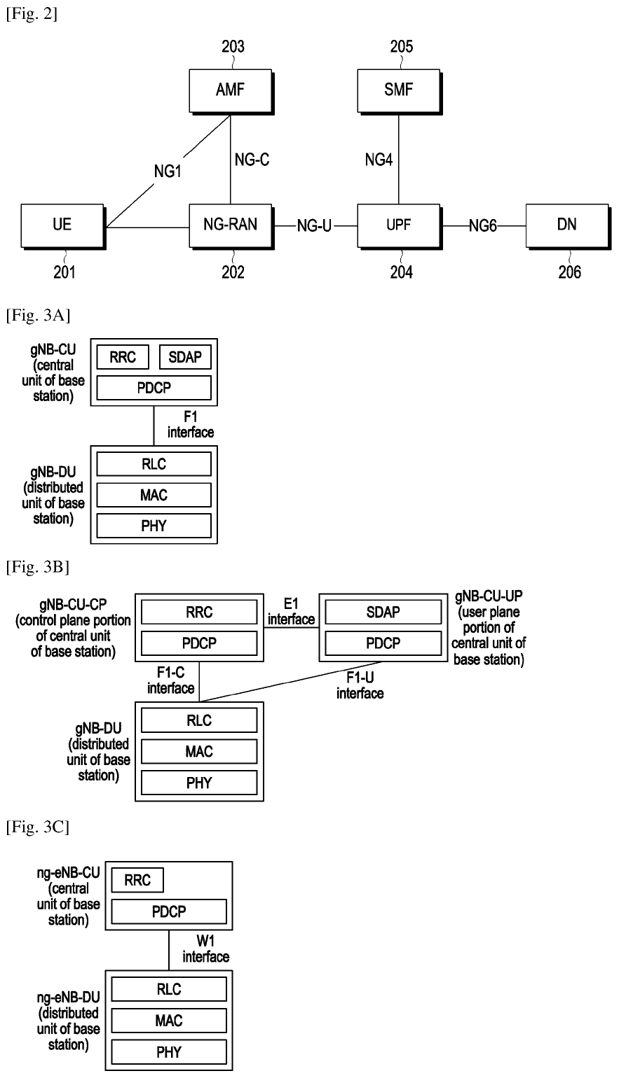

FIG. 2 illustrates an exemplary system architecture according to various embodiments of the present disclosure. Other embodiments of the system architecture can be used without departing from the scope of the present disclosure.

A user equipment (UE) 201 is a terminal device for receiving data. A Next Generation Radio Access Network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity (SMF) 205 is responsible for session management. A data network (DN) 206 includes, for example, services of operators, access of Internet and service of third parties.

In a New Radio (NR) access network, in order to expand the coverage of the network, a relay network architecture, namely Integrated Access and Backhaul (IAB), is proposed. The architecture introduces a donor/anchor node and a relay node (such as an IAB node). The anchor node can be a standalone base station, or a base station composed of a central unit (CU) (IAB-donor central unit) and a distributed unit (DU) (IAB-donor distributed unit). The relay node includes a mobile terminal function and a distributed unit function (in another example, it can also be described that a relay node includes a mobile terminal portion and a distributed unit portion), wherein the mobile terminal function is used for communicating with an upper-level node of the relay node, and the distributed unit portion is used for communicating with a lower-level node of the relay node, and the distributed unit portion sets up a connection with the anchor node and serves the user equipment accessing the distributed unit portion. The network containing IAB nodes is a relay network. In order to further expand the coverage of the network, the current researches begin to consider the movement of relay nodes, such as deploying a relay node on a vehicle, so that the relay node can provide services to users on the vehicle.

FIG. 3A, FIG. 3B and FIG. 3C illustrate exemplary block diagrams of a base station structure according to various embodiments of the present disclosure.

In the NR system, in order to support network function virtualization, more efficient resource management and scheduling, the base station (gNB/ng-eNB) that provides a wireless network interface for the terminal (UE) can be further divided into a gNB central unit/ng-eNB central unit (gNB-CU/ng-eNB-CU) and a gNB distributed unit/ng-eNB distributed unit (gNB-DU/ng-eNB-DU) (referred to as CU and DU for short in the present disclosure), as shown in FIG. 3A. A gNB-CU has protocol layers of Radio Resource Control (RRC), Service Data Adaptation Protocol (SDAP) and Packet Data Convergence Protocol (PDCP), etc., and a ng-eNB-CU has RRC, PDCP layers. A gNB-DU/ng-eNB-DU has Radio Link Control (RLC), Medium Access Control (MAC) and physical layer (PHY), etc. There is a standardized public interface F1 between the gNB-CU and gNB-DU, and a standardized public interface W1 between the ng-eNB-CU and ng-eNB-DU. The F1 interface is divided into a control plane interface F1-C and a user plane interface F1-U. The transmission of the transmission network layer of F1-C is based on the Internet Protocol (IP). In order to transmit signaling more reliably, a Stream Control Transmission Protocol (SCTP) is added on top of IP. The protocol of the application layer is F1AP (see 3GPP TS38.473). SCTP can provide reliable application layer message transmission. The transport layer of F1-U is User Datagram Protocol (UDP)/IP, and the General Packet Radio Service (GPRS) tunneling protocol GTP-U is used to bear user plane Protocol Data Unit (PDU) on top of UDP/IP. Further, for gNB-CU, as shown in FIG. 3B, a gNB-CU may include a gNB-CU-CP (a control plane portion of the central unit of the base station) and a gNB-CU-UP (a user plane portion of the central unit of the base station); the gNB-CU-CP includes the functions of the control plane of the base station and has RRC and PDCP protocol layers, and the gNB-CU-UP includes the functions of the user plane of the base station and has SDAP and PDCP protocol layers. There is a standardized public interface E1 between the gNB-CU-CP and gNB-CU-UP, and the protocol is E1AP (see 3GPP TS38.463). An interface between the control plane portion of the central unit of the base station and the distributed unit of the base station is the F1-C interface, that is, the control plane interface of F1, and an interface between the user plane portion of the central unit of the base station and the distributed unit of the base station is the F1-U interface, that is, the user plane interface of F1. In addition, in the NR system, the base station that accesses the 5G core network and provides the E-UTRA user plane and control plane is called a ng-eNB. In order to support virtualization, such base station (ng-eNB) can also be further divided into a gNB central unit/ng-eNB central unit (ng-eNB-CU) and a gNB distributed unit/ng-eNB distributed unit (ng-eNB-DU) (referred to as CU and DU for short in the present disclosure), as shown in FIG. 3C. The ng-eNB-CU has RRC, PDCP layers. The gNB-DU/ng-eNB-DU has Radio Link Control (RLC), Medium Access Control (MAC) and physical layer, etc. There is a standardized public interface W1 between ng-eNB-CU and ng-eNB-DU. The W1 interface is divided into a W1-C interface of the control plane portion and a W1-U interface (not shown) of the user plane portion. The Transmission of the transmission network layer of W1-C is based on IP. In order to transmit signaling more reliably, the SCTP protocol is added on top of IP. The protocol of the application layer is W1AP (see 3GPP TS37.473). The transport layer of W1-U is UDP/IP, and GTP-U is used to bear the Protocol Data Unit (PDU) of the user plane on top of UDP/IP.

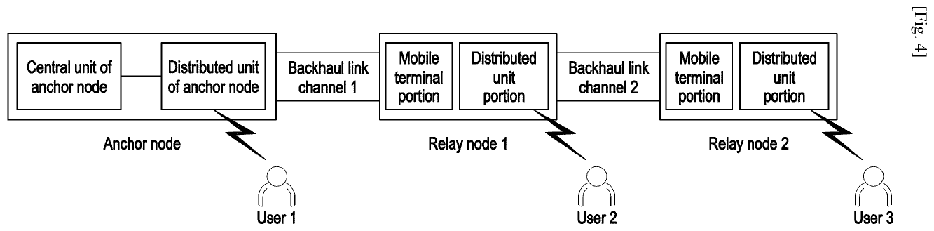

FIG. 4 illustrates a schematic architecture of a multi-hop relay network (IAB network), which shows a network architecture including an anchor node (such as IAB donor/anchor) and two relay nodes (e.g. relay node 1, relay node 2) (such as IAB nodes). Users in the multi-hop network can access the network through the anchor node or a distributed unit of the anchor node or the relay node. For example, users 1/2/3 access the relay network through the distributed unit of the anchor node, a distributed unit portion of a relay node 1, and a distributed unit portion of a relay node 2, respectively. The mobile terminal function of the relay node is used for communicating with an upper-level node of the relay node (for example, the mobile terminal portion of the relay node 1 is used for communicating with the anchor node or the distributed unit of the anchor node, and the mobile terminal portion of the relay node 2 is used for communicating with the distributed unit portion of the relay node 1), and the distributed unit portion of the relay node is used for communicating with a lower-level node of the relay node (for example, the distributed unit portion of the relay node 1 is used for communicating with the user 2, and can also be used for communicating with the mobile terminal portion of the relay node 2). The mobile terminal portion of a relay node can be regarded as a user accessing the network, so it has the function of an ordinary user (non-relay node) (for example, the mobile terminal portion can establish a Signaling Radio Bearer (SRB) with its upper-level node to send an RRC message, and can also establish a Data Radio Bearer (DRB) with its upper-level node to send data). Protocol stacks included in the central unit of the anchor node are: a protocol stack for serving the control plane, including a Radio Resource Control (RRC) protocol layer and a Packet Data Convergence Protocol (PDCP) layer; and a protocol stack for serving the user plane, including a Service Data Adaptation Protocol (SDAP) layer and a PDCP layer. The protocol stack included in the distributed unit of the anchor node or the distributed unit portion of the relay node is: a protocol stack for serving the control plane and the user plane, including a Radio Link Control (RLC) protocol layer, a Medium Access Control (MAC) protocol layer, and a Physical layer (PHY). An interface between the central unit of the anchor node and the distributed unit of the anchor node, and an interface between the central unit of the anchor node and the distributed unit portion of the relay node are F1 interfaces (see 3GPP TS38.473).

In the relay network, a link between the relay node and the anchor node or the distributed unit of the anchor node, or a link between the relay nodes, is a backhaul link, on which one or more different backhaul link channels are set up, such as a backhaul link channel 1 and backhaul link channel 2 in FIG. 4, wherein the backhaul link channel 1 is located between the anchor node and the relay node 1, and the backhaul link channel 2 is located between the relay node 1 and the relay node 2. An example of the backhaul link channel is a backhaul link Radio Link Control (RLC) channel, that is, a Backhaul link RLC channel. In the relay network, each backhaul link channel can be used to send packets belonging to the same user or different users. The data packet may be a data packet of a user Data Radio Bearer (DRB), or a data packet of a user Signaling Radio Bearer (SRB), can also be a data packet of the control plane on the F1 interface, or a data packet of the user plane on the F1 interface, or a data packet of a non-F1 interface (such as an Internet Protocol Security (IPSec) data packet, an SCTP protocol data packet, an Operation Administration and Maintenance (OAM) data packet, etc.).

In order to implement the transmission of user data in the multi-hop relay network, 3GPP defines a new protocol layer, namely a Backhaul Adaptation Protocol (BAP) layer, which will be configured in the distributed unit of the anchor node and in the relay node (such as the mobile terminal portion of a relay node, and/or the distributed unit portion of a relay node), is located above the RLC layer, and has main functions of routing of a data packet and mapping of the data packet. In order to send user data between the relay node and the anchor node, it is necessary to complete the configuration of the backhaul link and the configuration of the F1 connection between the distributed unit portion of the relay node and the anchor node. These configurations include but are not limited to the following types, such as BAP address, routing configuration (such as routing identity information, which indicates different transmission routes, and includes a BAP address and a path identity of a target receiving node), backhaul link channel configuration, tunnel configuration, backhaul link configuration for a tunnel, and the like.

After the relay network is introduced into NR, what is mainly considered is a scenario when the relay nodes are stationary. However, with a further development of research, the latest research has begun to consider the movement of relay nodes. In the process of moving, the relay node needs to frequently change an anchor node being connected. Because many users may be connected to the relay node, such movement will inevitably lead to a large signaling overhead, and will also interrupt the transmission of user data. In order to solve this problem, an existing solution is to connect the distributed unit portions of the relay node to the same anchor node, while the mobile terminal portion of the relay node changes a serving cell. In this way, the signaling overhead related to the distributed unit portion can be saved, and the time of data interruption can be reduced. However, this method is still given when the relay node does not move. When the relay node moves, this method may lead to a possibility that the data transmission of the relay node cannot be configured. This is because the change of the serving cell of the mobile terminal portion of the relay node and the control of the distributed unit portion of the relay node are managed by two different entities. In this way, when the mobile terminal portion of the relay node moves to a node unknown to the node connected to the distributed unit portion of the relay node, it is impossible to configure the data transmission of the relay node. This is one of the technical problems that the present disclosure intends to solve, that is, how to ensure continuous data transmission between the distributed unit portion of the relay node and the central unit of the connected anchor node during the movement of the relay node.

Before introducing the details, some assumptions and some definitions of the present disclosure are given below.
The message names in the present disclosure are just taken for example, and other message names can also be used.
The “first” and “second” contained in the message names of the present disclosure are just examples of messages, and do not represent the order of execution.
The detailed description of steps irrelevant to the present disclosure is omitted in the present disclosure.
In the present disclosure, the steps in each process can be executed in combination with each other, or can be executed separately. The execution order of the steps in each process is just an example, and other possible execution orders are not excluded.
In the present disclosure, the base station can be a 5G base station (such as a gNB, a ng-eNB), or a 4G base station (such as an eNB), or other types of access nodes.
In the present disclosure, the transmission of data refers to the reception or sending of data.
In the present disclosure, the uplink data refers to the data sent by the relay node to the base station (anchor node), and the downlink data refers to the data sent by the base station (anchor node) to the relay node.
In the present disclosure, the structure of the relay node referred to in the description of solution is that it includes a mobile terminal portion and a distributed unit portion, and the interface between the distributed unit portion of the relay node and the anchor node (or the central unit of the anchor node) is an F1 interface. However, the solution of the present disclosure is also applicable to a relay node of other structures. In one embodiment, another possible structure of the relay node is that it includes a mobile terminal portion and a base station portion, and the interface between the base station portion and the anchor node (or the central unit of the anchor node) is an Xn/X2 interface.

### Nodes Involved in the Present Disclosure are:

First node: a relay node. This node includes two portions, of which a first portion is used for the relay node to access the network, referred to as a first entity of the first node, and a second portion is used to serve other users, referred to as a second entity of the first node. In an example, this relay node is an IAB node, including an MT portion and a DU portion, then the first entity of the first node is the MT portion, and the second entity of the first node is the DU portion. In another embodiment, this relay node is a node with a base station function. If it includes an MT portion and a base station portion, then the first entity of the first node is the MT portion, and the second entity of the first node is the base station portion.
Second node: a base station, or a central unit of the base station, or a control plane portion of the central unit of the base station. The base station corresponding to the second node is a node connected to the first node. In one embodiment, the second node is a node that set up an RRC connection with the first node (or the first entity of the first node); in another embodiment, the second node is a node that has set up an interface (such as an F1 interface, an Xn/X2 interface) with the first node (the second entity of the first node); and in another embodiment, the second node is a node that sets up both an interface and an RRC connection with the first node. Specifically, the second node may be an anchor node of the first node, or a node having an anchor node function.
Third node: a base station, or a central unit of the base station, or a control plane portion of the central unit of the base station. The base station corresponding to the third node is a node connected to the first node. In one embodiment, the third node is a node that sets up an RRC connection with the first node (or the first entity of the first node); in another embodiment, the third node is a node that sets up an interface (such as an F1 interface, an Xn/X2 interface) with the first node (the second entity of the first node); and in another embodiment, the third node is a node that sets up both an interface and an RRC connection with the first node. Specifically, the third node may be an anchor node of the first node, or a node having an anchor node function.

In addition, the second node and the third node mentioned above may be different nodes, for example, the second node is a source node connected during the movement of the first node, and the third node is a target node connected during the movement of the first node.

In the present disclosure, the second node and the third node may be referred to as a first base station of a source cell and a second base station of a target cell, respectively.

In the following description, illustration is made by taking the first node being an IAB node as an example, and the interface set up by the second entity of the first node is an F1 interface. However, the solution described in the present disclosure is applicable to other types of relay nodes, and the following description about the F1 interface is also applicable to other types of interfaces set up between the second entity of the first node and the second node/third node.

### During a Migration Process, the Relay Node Needs to Perform Two Operations:

1) The distributed unit portion of the relay node set up a connection with the target anchor node, such as setting up an F1 interface
2) Migration of the user equipment context, that is, transferring the context of the user equipment served by the relay node from the source anchor node to the target anchor node

If both of the above two operations occur after the relay node (the mobile terminal portion thereof) is handed over to the target anchor node, this will cause a large latency experienced by the user equipment accessing the relay node, which will affect the user's data transmission. In order to solve this technical problem, the present disclosure proposes two aspects:
First aspect: data packet transmission of the F1 interface of the relay node
Second aspect: the context migration of the user equipment accessing the relay node

### First Aspect: Data Packet Transmission of the F1 Interface of the Relay Node

After the relay node is handed over to the serving cell of the target anchor node, in order to continue to serve the user equipment accessing the relay node, it needs to set up a connection with the target anchor node, such as an F1 interface, so that the target anchor node and the relay node can perform F1 interface management and configuration of data transmission of user equipment. However, if the setup of the F1 interface occurs after the handover of the mobile terminal portion of the relay node, this will cause a latency in data transmission of the user equipment accessing the relay node. In order to solve this problem, the present disclosure proposes a mechanism for transmitting a data packet of the F1 interface before the mobile terminal portion of the relay node accesses the target cell. The mechanism includes two possible implementation methods, as shown in FIG. 5.

FIG. 5 illustrates a mechanism for setting up an F1 connection before a mobile terminal portion of a relay node accesses a target cell according to various embodiments of the present disclosure.
Method 1: As shown in FIG. 5(a), the migration relay node transmits the data packet of the F1 interface with the central unit (or the control plane portion of the central unit) of the target anchor node through the central unit (or the control plane portion of the central unit) of the source anchor node

In this method, the data packet of the F1 interface is transmitted through the central unit (or the control plane portion of the central unit) of the source anchor node, such as transmitted between the migration relay node and the central unit (or the control plane portion of the central unit) of the source anchor node through the RRC message, and transmitted between the central unit (or the control plane portion of the central unit) of the source anchor node and the central unit (or the control plane portion of the central unit) of the target anchor node through the XnAP message.
Method 2: As shown in FIG. 5(b), the migration relay node transmits the data packet of the F1 interface with the central unit (or the control plane portion of the central unit) of the target anchor node through the distributed unit of the source anchor node.

In this method, the data packet of the F1 interface is transmitted through the distributed unit of the source anchor node, such as transmitted between the migration relay node and the distributed unit of the source anchor node through the backhaul link, and transmitted between the distributed unit of the source anchor node and the central unit (or the control plane portion of the central unit) of the target anchor node through the IP network.

In one embodiment, the data packet of the F1 interface mentioned above can be a data packet of the control plane of the F1 interface, such as a data packet associated with SCTP on the F1 interface (such as an SCTP packet containing an IP header), a data packet including an F1 interface control plane message (such as an SCTP Chunk containing an IP header), and a data packet (such as an IP data packet) used to protect data of the control plane of the F1 interface, etc. In another embodiment, the data packet of the F1 interface mentioned above can be a data packet of the user plane of the F1 interface. In an example, the above-mentioned data packet may be an IP packet.

In one embodiment, the data packet of the F1 interface mentioned above may be a data packet used to set up the F1 interface; and in another embodiment, the data packet of the F1 interface mentioned above may be a data packet used to manage the F1 interface after the F1 interface is set up (such as a data packet containing control plane signaling of the F1 interface).

In the above two methods, if the data packet of the F1 interface is used to set up the F1 interface, then the setup of the F1 interface occurs before the migration relay node accesses the target cell (the cell served by the central unit (or the control plane portion of the central unit) of the target anchor node). Because the setup of the F1 interface takes time, in order to implement the above two methods, a conditional handover mechanism can be adopted, that is, the migration relay node only starts the procedure (random access procedure) of accessing the target cell served by the central unit (or the control plane portion of the central unit) of the target anchor node after a specific condition is met (such as the measured signal strength reaches a certain threshold). In this way, before the above specific condition is met, on one hand, the migration relay node can serve the user equipment based on the network controlled by the source anchor node, and on the other hand, the migration relay node can set up a connection with the central unit (or the control plane portion of the central unit) of the target anchor node through the central unit (or the control plane portion of the central unit) of the source anchor node or the distributed unit of the source anchor node, for example, set up an F1 interface.

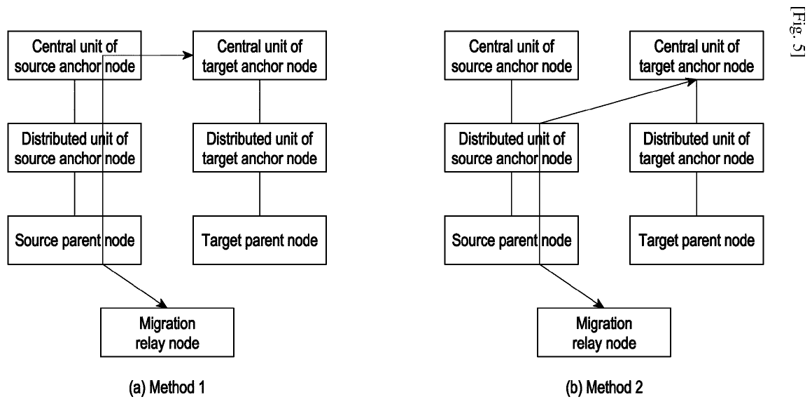

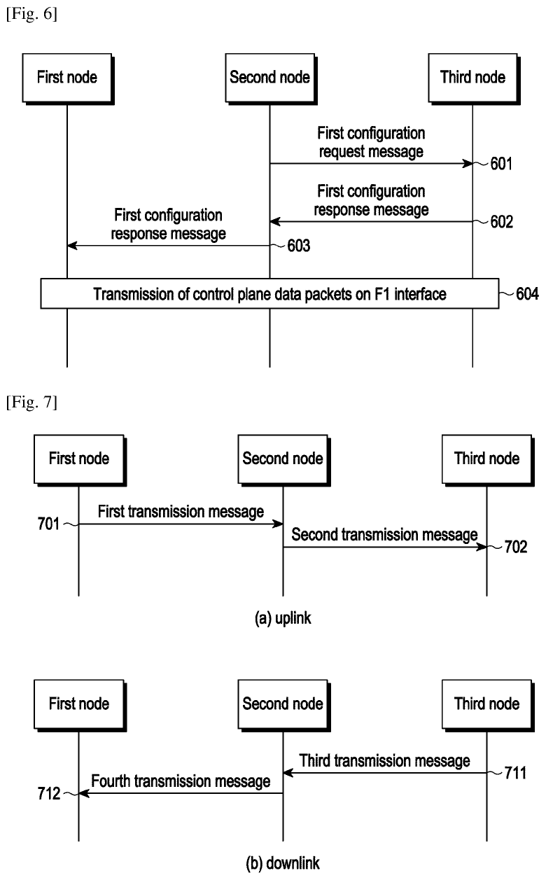

FIG. 6 illustrates an exemplary flow for setting up an F1 connection according to various embodiments of the present disclosure.

In the following, the configuration steps required to implement the above method are explained in detail, by taking an example that the first node may be the migration relay node, the second node may be the central unit (or the control plane portion of the central unit) of the source anchor node, and the third node may be the central unit (or the control plane portion of the central unit) of the target anchor node, as shown in FIG. 6.

Step 601: the second node sends a second message to the third node, for example, the second message may be a first configuration request message, and the function of the second message is to provide the third node with the configuration information of the first node in the network of the second node, so as to request the third node to provide the configuration information required for the migration of the first node. In an embodiment, the second message may be a handover request message for handover, and the second message may include at least one of:
> First target cell information. The function of this information is to provide information about the cell served by the third node and to be accessed by the first node, and the information may include at least one of:
>> Cell identity information, such as NR CGI (Cell Global Identity), PCI (Physical Cell Identity), E-UTRA CGI, etc
>> Conditional handover indication information. The function of this information is to indicate that the first node accesses the target cell according to the conditional handover mode. Specifically, the conditional handover means that the first node only accesses the cell indicated by the above “cell identity information” when the specific condition is met, wherein the specific condition may include but not limited to that the measured signal strength reaches a certain threshold
> First request indication information. The technical problem solved by this information is how the first node acquires the configuration information (such as IP address) of the third node so as to transmit a data packet therewith. In an embodiment, the function of this information is to request the third node to provide the configuration information (such as address information). Specifically, the requested address is the address information on the third node side used by the third node to set up the F1 interface with the first node (the distributed unit portion thereof).
> First configuration information. The technical problem solved by this information is how the third node sends the data packets for setting up the F1 interface to the first node. Because these data packets need to be transmitted through the network controlled by the second node, thus, the function of this information is to provide the third node with the configuration information used when transmitting the data packets required to set up the F1 interface. In one embodiment, the information is information used when implementing the method 2 above. Specifically, the information is information used when the third node sends the data packet to the distributed unit of the source anchor node. The information may include at least one of:
>> Address information on (the distributed unit portion of) the first node side, such as IP address information. Further, the address information is associated with the above “first target cell information”, that is, if the first node accesses the third node through the cell indicated by the above “first target cell information”, the first node will use the address indicated by the address information to perform data transmission on the F1 interface with the third node
>> Configuration information of a data packet, such as a configured value of the Differentiated Services Code Point (DSCP) field in the data packet, or a configured value of the flow label field. Specifically, when the third node sends a data packet for setting up the F1 interface to (the distributed unit portion of) the first node, the third node needs to set the field of the data packet according to the information. In this way, when the distributed unit of the anchor node receives the data packet containing this field, it can be seen that the data packet is sent to the first node

Further, in order to acquire the above-mentioned “address information on the first node side”, before the step 601, the method may further include a process that the second node obtains the address information from the first node: a. the second node sends a message for requesting an address to the first node. The message may include indication information for requesting an address, and the information instructs the first node to provide address information thereof used for setting up an F1 interface. Further, the indication information may also include identity information of the cell corresponding to the address information, and the cell is a candidate target cell (the cell served by the third node) accessed by (the mobile terminal portion of) the first node, that is, when the first node sets up the F1 interface with the third node, the first node will select the address used according to the candidate target cell accessed by the mobile terminal portion thereof; b. the first node sends a message for notifying the address information to the second node. The message may include address information on the first node side, and may further include identity information of a candidate target cell corresponding to the address.

Step 602: the third node sends a third message to the second node, for example, the third message may be a first configuration response message, and the function of the third message is to provide the second node with the configuration information for the first node to access the target cell. In an embodiment, the message may be a Handover Request Acknowledge message for handover, and the message may include at least one of:
> Second target cell information. This information indicates the target cell corresponding to the first configuration response message, the target cell is a cell served by the third node, and the information may include the identity information of the cell, such as NR CGI, PCI, E-UTRAN CGI, etc. In one embodiment, the cell indicated by the information is the identity information of the requested cell when performing a conditional handover (that is, the first node will access the target cell in a conditional handover mode), such as the requested target cell ID
> First response indication information. The technical problem solved by this information is how the first node acquires the configuration information on the third node side. In one embodiment, the information may be a response to the “first request indication information” in the step 601. In one embodiment, the information provides address information on the third node side required when setting up the F1 interface. This information may include at least one of:
>> Identity information of a connection. This information indicates an identity of the connection (such as an F1 connection) set up between the first node and the third node
>> Address information of the third node, such as IP address information, and/or port information. In one embodiment, the information may be included in an RRC container, and further, the second node will send the information to (the mobile terminal portion of) the first node through an RRC message. In another embodiment, the address information corresponds to the target cell indicated by the above “second target cell information”, that is, if the first node accesses a cell indicated by the above “second target cell information”, then the first node needs to use the “address information of the third node” corresponding to the cell to set up the F1 interface, or the F1 interface set up by the first node through the “address information of the third node” is for the first node to access the cell indicated by the above “second target cell information”
>> Indication information of an address of the third node. This information is used for indicating the address of the third node used when setting up the F1 interface. In one embodiment, the indication information may indicate the identity information of the target cell corresponding to the address of the third node. Specifically, when two or more target cells correspond to the same address of the third node, the third node may indicate that the address of the third node corresponding to one target cell is the same as the address of the third node corresponding to another target cell through the indication information. For example, addresses of the third node corresponding to target cell 1 and target cell 2 are both address 1; for target cell 1, the third node will set the “second target cell information” as target cell 1 and the “address information of the third node” as address 1 in the message in the step 602; for target cell 2, the third node will set the “second target cell information” to target cell 2, and set the “indication information of the address of the third node” to target cell 1 in the message in the step 602, which means that the address of the third node corresponding to target cell 2 is the same as the address of the third node corresponding to target cell 1. In another embodiment, the indication information may indicate the “identity information of the connection” corresponding to the address of the third node, that is, the information indicates the identity of the connection corresponding to the address of the third node

Step 603: the second node sends a first message to the first node; for example, the first message may be a first node configuration message. The function of the first message is to configure the first node to access a target cell and set up an F1 connection with the third node; and the message may include at least one of:
> Configuration information of a node. This information indicates the configuration information of the third node, and the information may include at least one of:
>> Address information of the third node, for example, IP address information, and/or port information
>> Indication information of an associated cell. The technical problem solved by the information is how to determine the configuration of the F1 connection corresponding to the cell after the first node accesses a target cell. The information indicates the identity information of one or more cells associated with the above-described “address information of the third node”, and the cells are cells served by the third node. Specifically, after the first node accesses the cell indicated by the information, the first node may learn that the F1 connection set up by the above-described “address information of the third node” is for the cell indicated by the “indication information of the associated cell”
> First transmission configuration information. This information indicates the configuration information required to transmit the data packet on the F1 interface; in one embodiment, the data packet on the F1 interface is a data packet of the control plane, for example, a data packet associated with the SCTP on the F1 interface (e.g., a SCTP packet containing an IP header), a data packet containing the F1 interface control plane message (e.g., a SCTP CHUNK containing an IP header), a data packet (e.g., a IP data packet) used for protecting the control plane data of the F1 interface; and the information may include at least one of:
>> RRC indication information, the information indicates that the data packet on the above-described F1 interface (or the control plane data packet on the F1 interface) is transmitted through an RRC message; in one example, the information may be the indication information of “F1-C over RRC”; in one embodiment, the information may be used in the above-described method 1
>> Configuration information of a backhaul link. This information indicates the configuration information of the backhaul link used for transmitting the data packet on the above-described F1 interface (or the control plane data packet on the F1 interface); in one embodiment, the information may be used in the above-described method 2. The information may include at least one of:
>>> Identity information of a backhaul link channel
>>> Address information of a next hop node, for example, BAP address information
>>> Indication information of an associated cell. This information indicates the identity information of the target cell targeted by the data packet transmitted on the backhaul link
>>> Address information of an associated third node. This information indicates the address of the third node targeted by the data packet transmitted on the backhaul link
>>> Identity information of an associated F1 connection. This information indicates the F1 connection targeted by the data packet transmitted on the backhaul link.
>>> Identity information of the associated third node. This information indicates the third node targeted by the data packet transmitted on the backhaul link

Based on the above-described steps, the first node may set up an F1 connection with the third node through the network controlled by the second node; when the F1 interface is set up/managed by using the above-described method 2, the first node may transmit the data packet of the F1 interface through the backhaul link configured in the step 603. When the above-described method 1 is used for setting up the F1 interface, the method may further include:

Step 604: the first node and the third node transmit the data packet on the F1 interface through the RRC message and the XnAP message. In one embodiment, the data packet may be a control plane data packet.

FIG. 7 illustrates an exemplary flow for performing transmission of a data packet on an F1 interface according to various embodiments of the present disclosure.

Specifically, as shown in FIG. 7(a), when the data packet is sent from the first node to the third node, the step 604 of FIG. 6 may include:

Step 701: the first node sends a fourth message to the second node; for example, the fourth message may be a first transmission message; in one embodiment, the message may be an RRC message; and the message may include at least one of:
> A first container. The container contains the data packet on the F1 interface that is sent by the first node to the third node. In one embodiment, the data packet on the F1 interface may be a data packet of the control plane
> Indication information of an associated cell. This information indicates the identity information of the target cell targeted by the data packet contained in the above-described “first container”. In one embodiment, the data packet contained in the above-described “first container” is used for setting up/managing the F1 interface between the first node accessing the cell and the third node
> Identity information of an associated F1 connection. This information indicates the identity information of the F1 connection targeted by the data packet contained in the above-described “first container”. In one embodiment, the data packet contained in the above-described “first container” is used for setting up/managing the F1 interface identified by the identity information between the first node and the third node

Step 702: the second node sends a fifth message to the third node; for example, the fifth message may be a second transmission message. In one embodiment, the message may be an XnAP message, and the message may include at least one of:
> The first container. The container contains the data packet on the F1 interface that is sent by the first node to the third node. In one embodiment, the data packet on the F1 interface may be a data packet of the control plane
> Indication information of the associated cell. This information indicates the identity information of the target cell targeted by the data packet contained in the above-described “first container”; in one embodiment, the data packet contained in the above-described “first container” is used for setting up/managing the F1 interface between the first node accessing the cell and the third node
> Identity information of the associated F1 connection. This information indicates the identity information of the F1 connection targeted by the data packet contained in the above-described “first container”; in one embodiment, the data packet contained in the above-described “first container” is used for setting up/managing the F1 interface identified by the identity information between the first node and the third node

When the data packet is sent from the third node to the first node, as shown in FIG. 7(b), the step 604 of FIG. 6 may include:

Step 711: the third node sends a seventh message to the second node; for example, the seventh message may be a third transmission message; in one embodiment, the message may be an XnAP message, and the message may include at least one of:
> A second container. The container contains the data packet on the F1 interface that is sent by the third node to the first node; in one embodiment, the data packet on the F1 interface may be a data packet of the control plane
> Indication information of an associated cell. This information indicates the identity information of the target cell targeted by the data packet contained in the above-described “second container”; in one embodiment, the data packet contained in the above-described “second container” is used for/managing the F1 interface between the first node accessing the cell and the third node
> Identity information of an associated F1 connection. This information indicates the identity information of the F1 connection targeted by the data packet contained in the above-described “second container”; in one embodiment, the data packet contained in the above-described “second container” is used for setting up/managing the F1 interface identified by the identity information between the first node and the third node

Step 712: the second node sends a sixth message to the first node; for example, the sixth message may be a fourth transmission message; in one embodiment, the message may be an RRC message, and the message includes at least one of:
> The second container. The container contains the data packet on the F1 interface that is sent by the third node to the first node. In one embodiment, the data packet on the F1 interface may be a data packet of the control plane
> Indication information of an associated cell. This information indicates the identity information of the target cell targeted by the data packet contained in the above-described “second container”. In one embodiment, the data packet contained in the above-described “second container” is used for setting up/managing the F1 interface between the first node accessing the cell and the third node
> Identity information of an associated F1 connection. This information indicates the identity information of the F1 connection targeted by the data packet contained in the above-described “second container”. In one embodiment, the data packet contained in the above-described “second container” is used for setting up/managing the F1 interface identified by the identity information between the first node and the third node

In the above-described steps, the connection (e.g., the interface) between the first node and the third node is set up before the first node accesses the target cell. In another example, the above-described steps may also be used for setting up the connection (e.g., the interface) between the first node and the third node after the first node accesses the target cell.

The first configuration request message and the first configuration response message as described above may respectively be a Handover Request message and a Handover Request Acknowledge message; and those skilled in the art should understand that the first configuration request message and the first configuration response message as described above may also be other messages without departing from the scope of the present disclosure. The above-described first node configuration message may be an RRC Reconfiguration message; and those skilled in the art should understand that the above-described first node configuration message may also be other message without departing from the scope of the present disclosure. The above-described first transmission message may be a ULInformationTransfer message; the second transmission message may be a transmission F1-C Transfer message of the F1-C interface; the third transmission message may be a DLInformationTransfer message; the fourth transmission message may be respectively a transmission F1-C Transfer message of the F1-C interface; and those skilled in the art should understand that the above-described first transmission message/second transmission message/third transmission message/fourth transmission message may also be other messages without departing from the scope of the present disclosure. The technical effects of the above-described steps are that: the migration relay node may set up a connection (e.g., the F1 interface) with the central unit (or the control plane portion of the central unit) of the target anchor node before accessing the target cell, so that node migration may be prepared in advance (e.g., the configuration of the user equipment accessing the relay node is sent to the target anchor node in advance, the target cell is configured for the user equipment in advance, etc.), to reduce interruption and latency of data transmission of the user equipment accessing the relay node during migration.

The data packet transmitted in the step 604 of FIG. 6 may be used for setting up a connection (e.g., the F1 interface) between the first node and the third node. When the first node accesses the target cell of the third node by means of a conditional handover, the first node may set up a connection (e.g., the F1 interface) with the third node before accessing the target cell. Because setup of the F1 interface is associated with the cell accessed by the first node, there may be a need of setting up different F1 interfaces for different target cells, so that one migration relay node needs to set up a plurality of F1 interfaces, which is different from the prior art, that is, one distributed unit portion can only set up an F1 interface with one central unit (or the control plane portion of the central unit). Usually, one migration relay node contains only one distributed unit portion; in order to set up a plurality of F1 interfaces for one relay node, a plurality of distributed unit portions need to be included, which increases design complexity of relay node. In practice, after the first node accesses one target cell, those F1 interfaces that are no longer associated with the target cell need not to be reserved. In order to solve the technical problem, the present disclosure proposes a conditional setup mechanism of the interface. In the mechanism, configuration of the cell served by the migration relay node is given based on conditions.

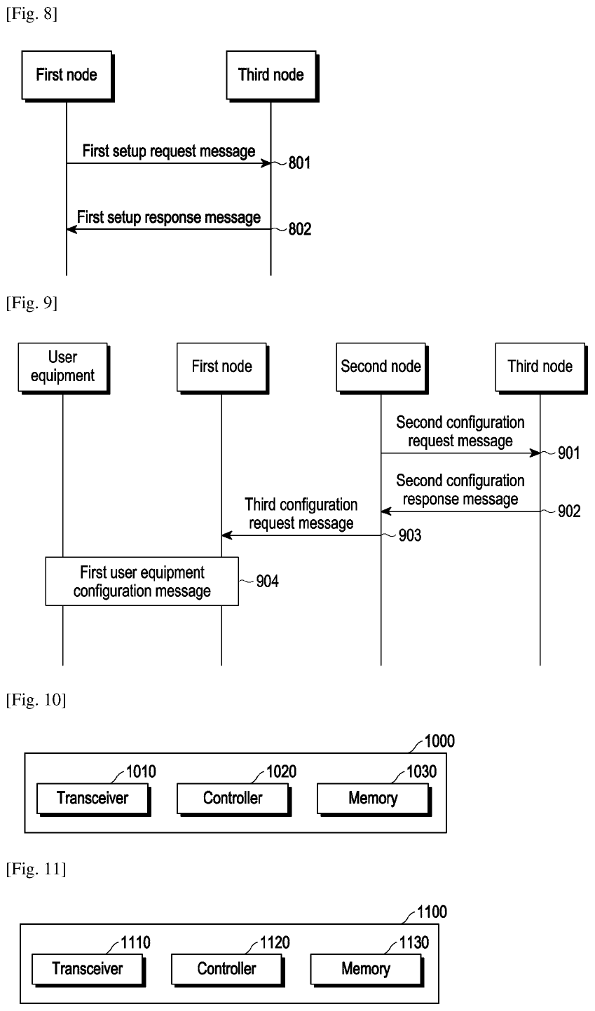

FIG. 8 illustrates an exemplary flow of a conditional setup mechanism of a connection according to various embodiments of the present disclosure.

Specifically, as shown in FIG. 8, the conditional setup mechanism includes steps below:

Step 801: the first node sends an eighth message to the third node; for example, the eighth message may be a first setup request message. The function of the message is to request setup of the connection (e.g., a interface (such as the F1 interface)) between the first node and the third node. In one embodiment, the message may be an F1 Setup request message. The message may include at least one of:
> Second configuration information. This information includes a configuration at the first node, and the information may include at least one of:
>> Information of a served cell. This information contains configuration information of the served cell at the first node, for example, a cell identity, a cell bandwidth, etc. For details, the Served Cell Information in TS38.473 may be referred to
>> Cell status information. This information indicates the status of the cell targeted by the above-described “information of the served cell”, for example, in-service (the cell is in service), out-of-service (the cell is not in service), and switch-off ongoing (the cell is about to be closed)
>> Address information. This information indicates the address information of (the distributed unit portion of) the first node, for example, IP address information (e.g., IP address information of IPSec, IP address information of GTP, inner IP address information, outer IP address information)
> Information of an associated cell. This information indicates the identity information of the target cell of (the mobile terminal portion of) the first node associated with one or more configurations in the above-described “second configuration information”, that is, only when the first node accesses the cell indicated by the “information of the associated cell”, the one or more configurations contained in the above-described “second configuration information” are the configurations used by the (distributed unit portion of) the first node

Step 802: the third node sends a ninth message to the first node; for example, the ninth message may be the first setup response message. The function of the message is to respond to the first setup request message in the step 801, configure the cell at the first node, and provide relevant configuration on the third node side; in one embodiment, the message may be the F1 Setup Response message, and the message may include at least one of:
> Third configuration information. This information includes the configurations at the first node, and the information may include at least one of:
>> Information of an activated cell. This information contains information of a cell to be activated as requested by the third node, for example, a cell identity, a cell system message, cell configuration information related to IAB, etc. For details, Cells to be Activated List in TS38.473 may be referred to
>> Address information. This information indicates the address information of the third node, for example, IP address information (e.g., IP address information of IPSec, IP address information of GTP, inner IP address information, outer IP address information)
>> Backhaul link mapping information. This information indicates configuration of the backhaul link used by the first node when transmitting the control plane data packet of the F1 interface, for example, an identity of the backhaul channel, a BAP address of the next hop node, and a routing identity, etc.; in one embodiment, the backhaul link may be a backhaul link in a network managed by the third node
> Information of an associated cell. This information indicates the identity information of the target cell of (the mobile terminal portion of) the first node associated with one or more configurations in the above-described “third configuration information”, that is, only when the first node accesses the cell indicated by the “information of the associated cell”, the one or more configurations contained in the above-described “third configuration information” are the configurations used by the (distributed unit portion of) the first node

The first setup request message and the first setup response message as described above may respectively be the F1 setup request message and the F1 setup response message; and those skilled in the art should understand that the first setup request message and the first setup response message as described above may also be other messages without departing from the scope of the present disclosure.

The technical effects of the above-described the steps 801 and 802 are that: the migration relay node only needs to set up one F1 connection with the central unit (or the control plane portion of the central unit) of the target anchor node, which reduces complexity for implementing the relay node, and also reduces overhead of signaling interaction of the first node with the third node (e.g., the central unit of the third node, the control plane portion of the central unit of the third node) through the second node (e.g., the central unit of the second node, the control plane portion of the central unit of the second node, and the distributed unit of the anchor node).

### Second Aspect: Context Migration of the User Equipment Accessing the Relay Node

The flow in the above-described first aspect ensures that the migration relay node may set up a connection (e.g., the F1 interface) with the target anchor node before accessing the target cell. Since the migration relay node also has some user equipment to serve, the source anchor node needs to migrate the user equipment to the target anchor node as well. Such a process usually occurs after setting up the F1 interface with the target anchor node. Context migration of each piece of user equipment is equivalent to the handover process of the user equipment, and the process also takes time. If the process occurs after the migration relay node accesses the target cell, data transmission of the user equipment accessing the migration relay node will be interrupted. In order to solve this problem, we also adopted the idea of the above-described first aspect, that is, to advance context migration of the user equipment by means of a conditional handover of the migration relay node, that is, before accessing the target cell, the migration relay node firstly sets up a connection (e.g., the F1 interface) with the target anchor node through the network managed by the source anchor node, and then performs context migration of the user equipment, meanwhile, the data of the user equipment accessing the migration relay node is still transmitted through the network managed by the source anchor node. The advantageous effect of the method is that interruption of data transmission of the user equipment may be reduced. In the prior art, the target cell of the user equipment is determined during the handover process of the user equipment, so the target base station may prepare a configuration message related to the target cell for the user equipment. However, in the scenario considered by the present disclosure, the target cell of the user equipment depends on the target cell accessed by the migration relay node, that is, the target cell accessed by the user equipment is different if the target cell accessed by the migration relay node is different. However, because the migration relay node performs the conditional handover, the target cell accessed by the migration relay node cannot be determined during user equipment handover (context migration); and thus, the target cell of the user equipment cannot be determined, that is, a technical problem in the context migration process of the user equipment is how to perform user equipment context migration when the target cell is unknown. In order to solve the technical problem, the present disclosure proposes a conditional distribution mechanism based on multiple configurations. A main idea of the mechanism is that: the target node determines a plurality of alternative target cells according to the source cell where the user equipment is located; determination of the target cell is based on the target cell accessed by the migration relay node, and the configuration message for each target cell is sent to the source node. The source node will send these configuration messages to the migration relay node, and the migration relay node caches these messages. When certain conditions are met, the migration relay node determines or selects an appropriate configuration message to send to the user equipment.

FIG. 9 illustrates an exemplary flow of context migration of a user equipment according to various embodiments of the present disclosure.

As shown in FIG. 9, the context migration mechanism may include a flow below:

Step 901: the second node sends a second message to the third node; for example, the second message may be a second configuration request message, the function of the message is to provide configuration of the user equipment at the second node; the message may at least include information of the source cell of the user equipment (e.g., an identity and an address, etc. of the source cell); in one embodiment, the second configuration request message may be a Handover Request message. Since the target cell of the user equipment cannot be determined, the identity information of the target cell contained in the existing message (i.e., the Handover Request message) may be ignored.

Step 902: the third node sends a third message to the second node; for example, the third message may be a second configuration response message; the function of the message is to provide configuration of the user equipment at the third node; in one embodiment, the second configuration response message may be a Handover Request Acknowledge message. In order to overcome the technical problem that the target cell of the user equipment may be different because the target cell accessed by the first node is different, the third node will generate different configuration messages for different target cells; for example, for a target cell, the message may include at least one of:
> Indication information of accepted data; in one embodiment, the information may indicate a PDU session of the data of the user equipment accepted by the target cell; and the information may include at least one of:
>> Identity information of the PDU session
>> Resource configuration information of the PDU session, for example, Quality of Service QoS flow information and data forwarding information
>> Identity information of an associated cell. The associated cell is a target cell of (the mobile terminal portion of) the first node, that is, when (the mobile terminal portion of) the first node accesses the cell, the PDU session indicated by the above-described “identity information of the PDU session” is the accepted session
> A third container. The container contains configuration required to configure the user equipment to access the target cell. For details, the Handover Command information in TS38.331 may be referred to. The container will indicate the identity of the target cell of the user equipment. In one embodiment, the target cell may be determined according to the source cell of the user equipment learned in the step 901. Specifically, when (the mobile terminal portion of) the first node is migrated to the target cell, the served cell of (the distributed unit portion of) the first node may be determined accordingly; these cells are actually reconfiguration of the cells served when the first node is connected to the second node, for example, changing the cell identity (a NR CGI, a PCI, etc.), so that the third node may learn the possible target cell of the user equipment according to the source cell of the user equipment
> Identity information of the target cell of the user equipment, for example, a NR CGI, a PCI, etc.
> Identity information of an associated cell. Only when the associated cell is the target cell of (the mobile terminal portion of) the first node, that is, (the mobile terminal portion of) the first node accesses the cell, the target cell indicated in the third container is the target cell of the user equipment, and the user equipment can access the target cell according to configuration in the container.

Implementation of the step 902 is different from implementation of user equipment conditional handover. In the conditional handover process, for a candidate target cell, the source base station needs to start a handover preparation process, and in the process, the target base station will only provide a configuration message for one target cell. However, in the above-described the step 902, the third node prepares a plurality of configuration messages for different target cells in one message.

According to the step 902, the second node may receive one or more configuration messages for the target cell of the user equipment, and these configuration messages are associated with the target cell of the first node.

Step 903: the second node sends a first message to (the distributed unit portion of) the first node; for example, the first message may be a third configuration request message; the function of the message is to send a message about the configuration of the user equipment in the target cell; in one embodiment, the message may be the UE CONTEXT MODIFICATION REQUEST message of the F1 interface; further, the message is sent by the network managed by the second node; and for a target cell of the user equipment, the message may include at least one of:
> A fourth container. The container contains the configuration required to configure the user equipment to access the target cell. For details, the Handover Command information and the RRCReconfiguration message in TS38.331 may be referred to. The container will indicate the identity of the target cell of the user equipment
> Identity information of the target cell of the user equipment, for example, a NR CGI, a PCI, etc.
> Identity information of an associated cell. Only when the associated cell is the target cell of (the mobile terminal portion of) the first node, that is, after (the mobile terminal portion of) the first node accesses the cell, the target cell indicated in the fourth container is the target cell of the user equipment, and the user equipment can access the target cell according to configuration in the container
> Indication information of a conditional transmission. The function of the information is to indicate the first node to send the message contained in the above-described fourth container to the user equipment after specific conditions are met

Step 904: the first node sends a tenth message to the user equipment; for example, the tenth message may be a first user equipment configuration message, the message contains the configuration information required by the user equipment to access the target cell; in one embodiment, the message may be an RRC Reconfiguration message. According to the configuration in the above-described the step 903, the first node will not send messages contained in all containers received in the step 903 to the user equipment, but will determine or select a message in an appropriate container to send to the user equipment according to specific conditions; in one embodiment, the “specific conditions” may be one or more of:
> Condition 1: (the mobile terminal portion of) the first node accesses a cell indicated by the above-described “identity information of the associated cell”
> Condition 2: the first node has sent all the cached data packets from the network (source path) managed by the second node to the user equipment
> Condition 3: the target cell of the user equipment has started to operate (has been activated)

The second configuration request message and the second configuration response message as described above may respectively be the Handover Request message and the Handover Request Acknowledge message; and those skilled in the art should understand that the second configuration request message and the second configuration response message as described above may also be other messages. The above-described third configuration request message may be the UE context modification request message of the F1 interface; and those skilled in the art should understand that the above-described third configuration request message may also be other messages. The above-described first user equipment configuration message may be an RRC Reconfiguration message; and those skilled in the art should understand that the above-described first user equipment configuration message may also be other messages.

The technical effects of the above-described steps are that: during user equipment context migration, the network prepares a plurality of alternative target cells for the user equipment in advance; after accessing the target cell, the migration relay node sends the appropriate configuration message to the user equipment according to specific conditions. In this way, it may be ensured that user equipment context migration may be completed before the relay node accesses the target cell, while maintaining data transmission of the user equipment in the source cell, to further reduce latency of user equipment data transmission and avoid interruption of data transmission.

FIG. 10 is a block diagram of a node according to an exemplary embodiment of the present disclosure. Here, a node is taken as an example to illustrate its structure and function. However, it should be understood that the structure and function shown can also be applied to a base station (or a central unit of the base station, or a control plane portion of the central unit of the base station, or a user plane portion of the central unit of the base station, or a distributed unit of the base station, etc.).

Referring to FIG. 10, a node 1000 includes a transceiver 1010, a controller 1020, and a memory 1030. Under the control of the controller 1020 (which may be implemented as one or more processors), the node 1000 (including the transceiver 1010 and the memory 1030) is configured to perform the operations of the node described above. Although shown as separate entities, the transceiver 1010, the controller 1020, and the memory 1030 may be implemented as a single entity, such as a single chip. The transceiver 1010, the controller 1020, and the memory 1030 may be electrically connected or coupled to each other. The transceiver 1010 may transmit a signal to and receive a signal from other network entities, such as another node and/or a UE, etc. In one implementation, the transceiver 1010 may be omitted. In this case, the controller 1020 may be configured to execute instructions (including computer programs) stored in the memory 1030 to control the overall operation of the node 1000, thereby implementing the operations of the node described above.

FIG. 11 is a block diagram of a user equipment according to an exemplary embodiment of the present disclosure.

Referring to FIG. 11, a user equipment 1100 includes a transceiver 1110, a controller 1120, and a memory 1130. Under the control of the controller 1120 (which may be implemented as one or more processors), the user equipment 1100 (including the transceiver 1110 and the memory 1130) is configured to perform the operations of the user equipment described above. Although shown as separate entities, the transceiver 1110, controller 1120, and memory 1130 may be implemented as a single entity, such as a single chip. The transceiver 1110, the controller 1120, and the memory 1130 may be electrically connected or coupled to each other. The transceiver 1110 may transmit a signal to and receive a signal from other network entities, such as a node, another UE, or the like. In one implementation, the transceiver 1110 may be omitted. In this case, the controller 1120 may be configured to execute instructions (including computer programs) stored in the memory 1130 to control the overall operation of the user equipment 1100, thereby performing the operations of the user equipment described above.

Those skilled in the art may realize that the present disclosure can be implemented in other specific forms without changing the technical idea or basic features of the present disclosure. Therefore, it should be understood that the above-mentioned embodiments are merely examples and not limitative. The scope of the present disclosure is defined by the appended claims rather than the detailed description. Therefore, it should be understood that all modifications or changes derived from the meaning and scope of the appended claims and their equivalents fall within the scope of the present disclosure.

In the above-described embodiments of the present disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the present disclosure has been illustrated and described with reference to various embodiments of the present disclosure, those skilled in the art will understand that various changes can be made in form and detail without departing from the spirit and scope of the present disclosure as defined by the appended claims and their equivalents.

1-14. (canceled)

15. A method performed by an integrated access and backhaul (IAB) node, the method comprising:
receiving, from a source node, a first message for triggering migration of the IAB node including information for F1 set up with a target node, wherein the information includes IP address of the target node;
transmitting, to the target node, a F1 setup request message for F1 setup when connecting to a network or for migration; and
receiving, from the target node, a F1 setup response message.

16. The method of claim 15, wherein the source node is a source IAB donor central unit (CU) establishing F1 connection with the IAB node during migration of the IAB node.

17. The method of claim 15, wherein the target node is a target IAB donor central unit (CU) establishing the F1 connection with the IAB node during the migration of the IAB node.

18. The method of claim 15, wherein the information includes information used by the IAB node for setting up the connection with a target base station before accessing a target cell of the target base station.

19. The method of claim 15,
wherein the information comprises at least one of node information, and first transmission configuration information,
wherein the node information comprises at least one of address information of a target base station, and indication information of an associated cell, and
wherein the first transmission configuration information comprises at least one of radio resource control (RRC) indication information, and configuration information of a backhaul link.

20. The method of claim 19, wherein the information of the backhaul link comprises at least one of identity information of a backhaul link channel, address information of a next hop node, the indication information of the associated cell, address information of the target base station, identity information of an associated F1 connection, and identity information of the target base station.

21. The method of claim 15, wherein the IAB node is handed over from a source cell to a target cell to serve the UE accessing the IAB node.

22. An integrated access and backhaul (IAB) node in a communication system, the IAB node comprising:
a transceiver; and
a processor configured to:
receive, from a source node, a first message for triggering migration of the IAB node including information for F1 set up with a target node, wherein the information includes IP address of the target node,
transmit, to the target node, a F1 setup request message for F1 setup when connecting to a network or for migration, and
receive, from the target node, a F1 setup response message.

23. The IAB node of claim 22, wherein the source node is a source IAB donor central unit (CU) establishing F1 connection with the IAB node during migration of the IAB node.

24. The IAB node of claim 22, wherein the target node is a target IAB donor central unit (CU) establishing the F1 connection with the IAB node during the migration of the IAB node.

25. The IAB node of claim 22, wherein the information includes information used by the IAB node for setting up the connection with a target base station before accessing a target cell of the target base station.

26. The IAB node of claim 22,
wherein the information comprises at least one of node information, and first transmission configuration information,
wherein the node information comprises at least one of address information of a target base station, and indication information of an associated cell, and
wherein the first transmission configuration information comprises at least one of radio resource control (RRC) indication information, and configuration information of a backhaul link.

27. The IAB node of claim 26, wherein the information of the backhaul link comprises at least one of identity information of a backhaul link channel, address information of a next hop node, the indication information of the associated cell, address information of the target base station, identity information of an associated F1 connection, and identity information of the target base station.

28. The IAB node of claim 22, wherein the IAB node is handed over from a source cell to a target cell to serve the UE accessing the IAB node.

29. A method performed by a source node, the method comprising:
generating a first message for triggering migration of an integrated access and backhaul (IAB) node; and
transmitting, to the IAB node, the first message including information for F1 set up with a target node, wherein the information includes IP address of the target node.

30. The method of claim 29, wherein the source node is a source IAB donor central unit (CU) establishing F1 connection with the IAB node during migration of the IAB node.

31. The method of claim 29, wherein the information includes information used by the IAB node for setting up the connection with a target base station before accessing a target cell of the target base station.

32. A source node in a communication system, the source node comprising:
a transceiver; and
a processor configured to:
generate a first message for triggering migration of an integrated access and backhaul (IAB) node, and
transmit, to the IAB node, the first message including information for F1 set up with a target node, wherein the information includes IP address of the target node.

33. The source node of claim 32, wherein a source node is a source IAB donor central unit (CU) establishing F1 connection with the IAB node during migration of the IAB node.

34. The source node of claim 32, wherein the information includes information used by the IAB node for setting up the connection with a target base station before accessing a target cell of the target base station.
